(19) United States
(12) Patent Application Publication
(10) Pub. No.: US 2008/0001358 A1
(43) Pub. Date: Jan. 3, 2008

(54) Method and device for conducting a game of chance

(76) Inventors: Kenneth A. Scott, Scottsdale, AZ (US); Matthourasy S. Soubannarath, Scottsdale, AZ (US)

Correspondence Address: ROBERT RYAN MORISHITA;MORISHITA LAW FIRM, LLC, 3800 HOWARD HUGHES PKWY,, SUITE 850, LAS VEGAS, NV, 89169, US

(21) Appl. No.: 11/801,875

(22) Filed: May 11, 2007

Related U.S. Application Data
(60) Provisional application No. 60/799,783, filed on May 11, 2006.

(51) Int. Cl. G06F 17/00

(52) U.S. Cl. 273/274; 463/25

(57) ABSTRACT

A method and device for conducting a game of chance using game indicia, e.g. faces of a die, includes displaying an array of game indicia positions, such as a 3×3 array representing nine dice. Players place one or more proposition wagers. A game indicium is randomly selected for each position. Line propositions are satisfied if a designated subset of the array, e.g. a row, column, or diagonal contains designated game indicia. Optionally, players are only rewarded for line propositions fulfilled on active lines. Pattern propositions are satisfied by game indicia appearing in selected patterns in the array. Optionally, pattern propositions require the player to specify the game indicia appearing the pattern or reward the player for any game indicia appearing in the selected pattern. Board propositions are satisfied by game indicia appearing across the array. Players are rewarded for propositions fulfilled.

### RELATED APPLICATION DATA

The present application claims the priority of U.S. Provisional Application Ser. No. 60/799,783, entitled “Method and Device for Conducting a Game of Chance,” filed May 11, 2006 by Applicants herein.

### FIELD OF THE INVENTION

The present invention relates to games of chance. More specifically, the present invention relates to methods and devices for conducting a game of chance in which a player wagers on propositions of randomly generated indicia patterns.

### BACKGROUND OF THE INVENTION

Sic Bo is a gambling game of Chinese origin. It is also known as Tai Sai or Dai Siu, meaning Big Small. It is played with three standard dice that are shaken in a basket or plastic cup. Traditionally, the dice were shaken on a small plate covered with a bowl, which was then lifted to reveal the roll.

Sic Bo is a single roll dice game in which players may wager on the sum of the dice. For example, the player may wager on the sum of fifteen without regard to the combination of dice required to form a fifteen, i.e. the wager would win if the dice show 5-5-5, 4-5-6, or 3-6-6. Alternatively or additionally, the player may wager on the combination of dice, for example, wagering on the combination of 5-5-5. Wagers may be placed on three-number combinations (with odds ranging from 5:1 to 50:1), two-number combinations, or on single-numbers (with odds ranging from one match paying 1:1, two matches paying 2:1, three matches paying 3:1, although in some casinos three matches may pay as high as 12:1). Players may also wager on special combinations such as doubles, in which two of the three dice show the same number, and triplets, in which all three of the dice show the same number. Double and triplet wagers may be on “Any Double” or “Any Triplet” or the player may select a specific double or triplet. Players may also wager on ranges of sums, such as “Big,” which pays the player when the sum total of the three dice is 11 through 17, inclusive, and “Small,” which pays the player when the sum total of the three dice is 4 through 10, inclusive, unless the sum total within the range occurs as a result of a triple.

To play the game, the player places wagers on specific propositions. The player can make any number of bets on the Sic Bo table. Three dice are rolled and all wagers are immediately resolved; that is, there are no multiple roll wagers in Sic Bo. Winning propositions can yield a pay-off ranging from 1:1 to 180:1. Payoff combinations are typically displayed on layout on a table surface. After a roll, winning propositions, i.e. dice combinations or sums that are fulfilled by the roll, are lighted from underneath the layout.

### SUMMARY OF THE INVENTION

The present invention is a method and device for conducting a wagering game using game indicia. In an optional embodiment, the game indicia are the indicia on the six faces of a conventional die, i.e. the numbers 1 through 6, inclusive, with each number having an equal probability of selection.

An array of game indicium positions are displayed. In an optional embodiment, the array is an array having two or more dimensions. For example, in an optional embodiment, the array is a rectangular array formed by columns and rows, such as a square 3×3 array of game indicium positions. In one such optional embodiment, the array includes nine game indicium positions each containing a separate six-sided die.

Players place a wager and select propositions on which to wager. Among the propositions offered are line propositions, pattern propositions, and/or board propositions. Line propositions are propositions that are satisfied by game indicia appearing in a designated subset of the array, such as a row, column, or diagonal. Examples could include three indicia along a row, column, or diagonal with adjacent numbers, two matching numbers, three matching numbers, or three designated matching numbers. In an optional embodiment, players must activate subsets, such as one or more row, column, or diagonal lines, such as by placing a wager on the activated line, and the player is only rewarded for line wager propositions fulfilled on active lines.

Pattern propositions are propositions that are satisfied by game indicia appearing in a pattern within the array. Examples could include game indicia in an X pattern formed by intersecting diagonals, game indicia in an L, T, +, box, or like pattern formed by one or more intersecting columns or rows, game indicia in a four-comers pattern, game indicia in a blackout pattern, or game indicia in any other pattern.

Board propositions are propositions that are satisfied by subsets of the entire board. Examples could include the characteristics of game indicia (size, odd/even, sum, or the like) throughout the array.

Game indicia are randomly selected to the game indicium positions in the array. In an optional embodiment, the game indicium for each game indicium position is selected separate and independent of the other game indicium positions.

Wagers are resolved by rewarding players for propositions that are fulfilled and collecting wagers on propositions that are not fulfilled. Optionally, rewards are based on the original wager, with pay outs of greater than even money available for certain propositions. In a further optional embodiment, additional rewards may be issued, such as jackpots based on the game indicia within the array or mystery pay outs that occur randomly during play.

The present invention also includes a device for conducting a game of chance. The device includes a data processor in communication with a display, data storage, an input device, and, optionally, a wager handling device. According to an embodiment of the present invention, the data processor receives wagering information from the input device. In an optional embodiment, particularly where line proposition wagers are made, wager selections are received at the input device. Wager selections may include selections of row, column, or diagonal lines within the array to activate.

The data processor randomly selects game indicia at each game indicia position in the array. Optionally, the game indicium at each game indicia position is selected independently. The array of game indicia is examined to determine if the propositions selection by the player have been fulfilled. As noted above, propositions may be line propositions, pattern propositions, or board propositions. In determining whether a line proposition has been fulfilled, the subsets wagered upon, i.e. the rows, columns, and/or diagonals or, in an optional embodiment, the active rows, active columns, and/or active diagonals, include the combination of game indicia needed to satisfy the proposition. In determining whether a pattern proposition has been fulfilled, game indicia fulfilling some criterion or criteria (such as matching game indicia) appear in a designated pattern (such as in a pattern of four comers, cross, +, X, T, L, or other patterns) in the array. In determining whether a board proposition has been fulfilled, the entire board is examined to determine whether a subset of the board satisfies the proposition. If one or more of the propositions selected by the player are satisfied, the player is rewarded.

### BRIEF DESCRIPTION OF THE DRAWINGS

FIG. 1 is a front view of a gaming machine according to an embodiment of the present invention;

FIG. 2A is a front view of an input device for a gaming machine according to FIG. 1;

FIG. 2B is a front view of an input device for a gaming machine according to FIG. 1 in an example game;

FIG. 3 is a block diagram of a device according to an embodiment of the present invention;

FIG. 4 is a flow chart of a method according to an embodiment of the present invention.

### DESCRIPTION

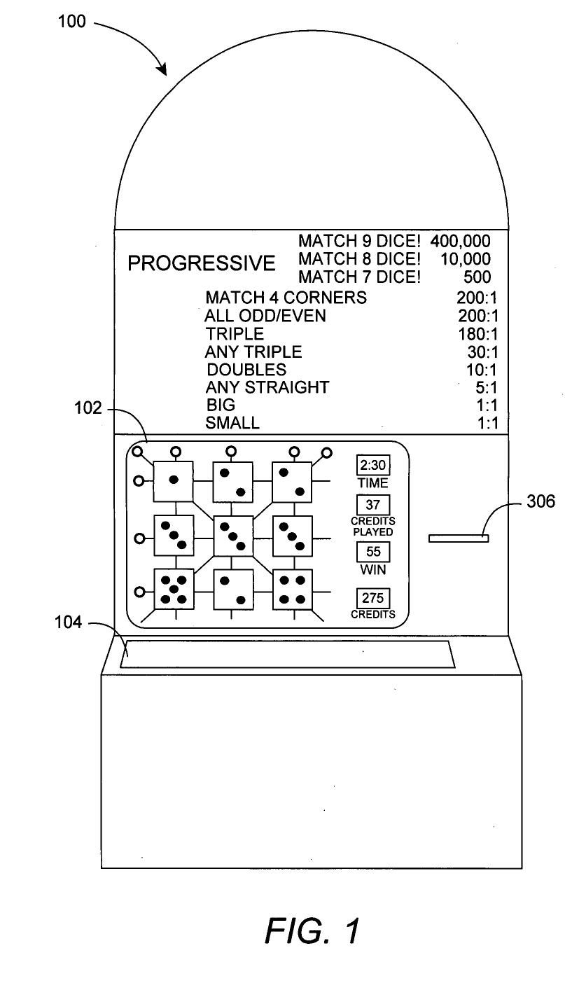

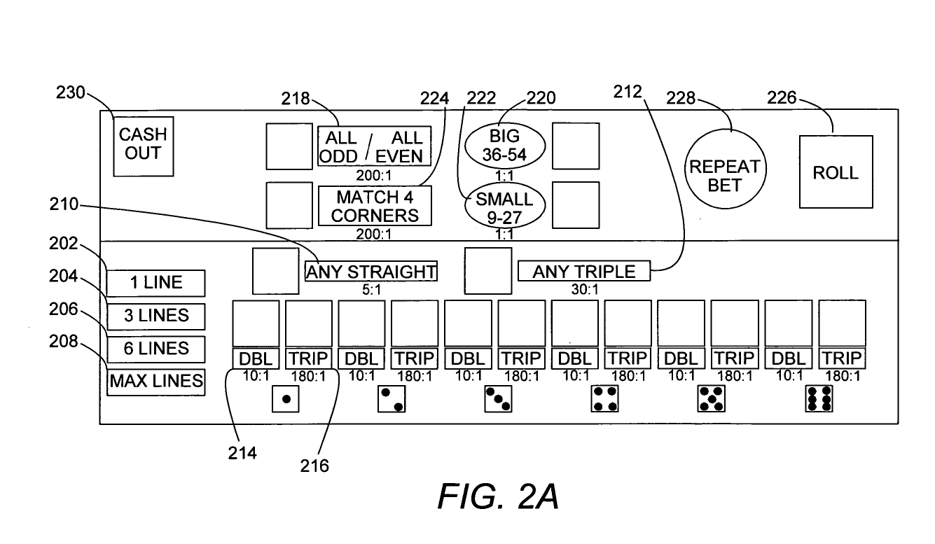

Reference is now made to the figures wherein like parts are referred to by like numerals throughout. Referring generally to FIGS. 1 and 2, the present invention includes a method and device for conducting a game of chance. The present invention may be conducted at any form of device, including a gaming machine 100, gaming table, kiosk, terminal, PC (in a standalone or networked configuration such as through the Internet), handheld device or PDA or cellular telephone, or any other device. The figures illustrate an embodiment directed primarily to a gaming machine 100, however, this should be considered illustrative only and not be considered limiting.

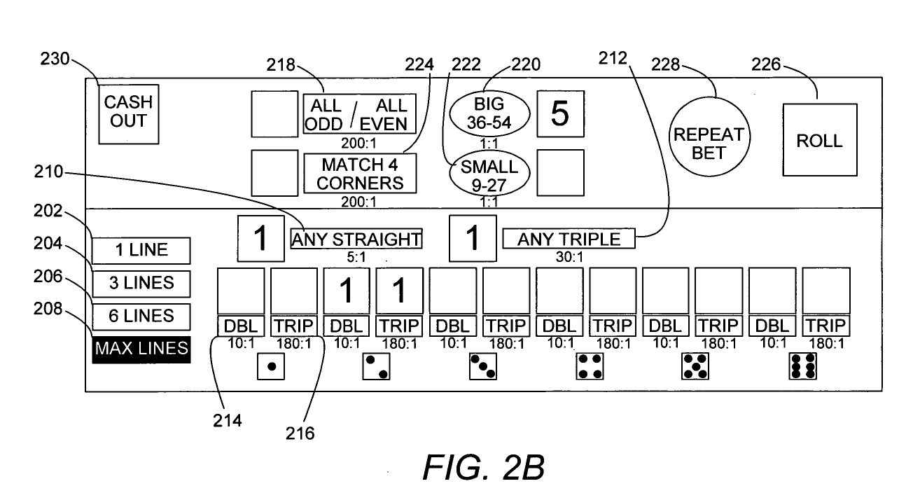

Referring first to FIGS. 1 and 3, a device according to the present invention may include a data processor 302 that incorporates or communicates with a data storage 304. The data storage 304 stores instructions executable by the data processor 302 to conduct a game according to an embodiment of the present invention, as well as game parameters such as pay tables, images of game indicia, propositions, and the like.

The data processor 302 communicates with, and controls, a display device 102. The display device 102 may take any form, including a cathode ray tube (“CRT”) monitor, a liquid crystal display (“LCD”), plasma display, or any other type of display. Additionally, it is contemplated that the display device 102 may be mechanical in that it displays physical objects rather than images or representations of objects.

A device may also include an input device 104 communicating with the data processor 302 to receive input from a player and communicate that input to the data processor 302. It is contemplated that the input device 104 could take many different forms, including a button panel, button fields on a touch screen, keyboard, keypad, or display buttons on a monitor that are activated using a controller such as a mouse, pointer, stylus, joystick, or the like. As shown in FIGS. 2A and 2B, the input device 104 may include a number of input options. In the example button panel of FIGS. 2A and 2B, the input device 104 includes input options for the quantity of lines to activate, in this example, a 1 LINE button 202, a 3 LINES button 204, a 6 LINES button 206, and a MAX LINES button 208 (which, in this example, would activate eight lines). The input device also includes buttons for selecting line propositions including an ANY STRAIGHT button 210, an ANY TRIPLE button 212, and a DBL (double) button 214 and a TRIP (triple) button 216 for each of six number options. In this optional embodiment, buttons for selecting board propositions include an ALL ODD/ALL EVEN button 218, a BIG button 220, and a SMALL button 222, and buttons for selecting pattern propositions include a MATCH 4 CORNERS button 224. The specific proposition wagers are discussed in greater detail below. Additional input options, e.g. buttons, may be provided if additional inputs, such as additional or alternative proposition wagers, are provided. Additionally, input options for input other than wager selections could include a ROLL button 226, a REPEAT BET button 228, and a CASH OUT button 230.

Returning to FIGS. 1 and 3, a device according to an optional embodiment of the present invention may include a wager handing device 306. For example, the gaming machine of FIG. 1 includes a coin slot and a bill/voucher receiver. Typically, a player inserts one or more coins, bills, or vouchers into a gaming machine which is retained by the gaming machine as stored game credit. As the player plays the gaming machine, the player wagers with, and is rewarded in, game credit. When the player wishes to leave the gaming machine, the player “cashes out” by converting the game credit to coin, currency, or voucher. Thus, it is contemplated that the wager handling device 306 may include wager receiving as well as reward issuing capability. For example, the wager handling device 306 may take many forms, including a ticket-in/ticket-out receiver/printer, card reader, credit reader, or any other form of device to receive a wager, or an electronic representation thereof, as well as issue a reward, or an electronic representation thereof.

In one optional embodiment, players input wagering information at the input device, such as wager selections of which propositions the player wishes to take and the amount to stake on each proposition. As shown in FIG. 2, each proposition may include a button corresponding therewith that can be used to select that proposition. Also, one or more wager amount buttons may be provided to select the amount of the wager on that proposition.

Turning to a method of conducting a game according to the present invention, the game is conducted using a set of game indicia. In one optional embodiment, shown in FIGS. 1, 2A, and 2B, the game indicia are the six sides of a conventional cubic die. In one such optional embodiment, the game indicia are the numbers one through six, or the conventional arrangement of one through six pips commonly seen on cubic dice.

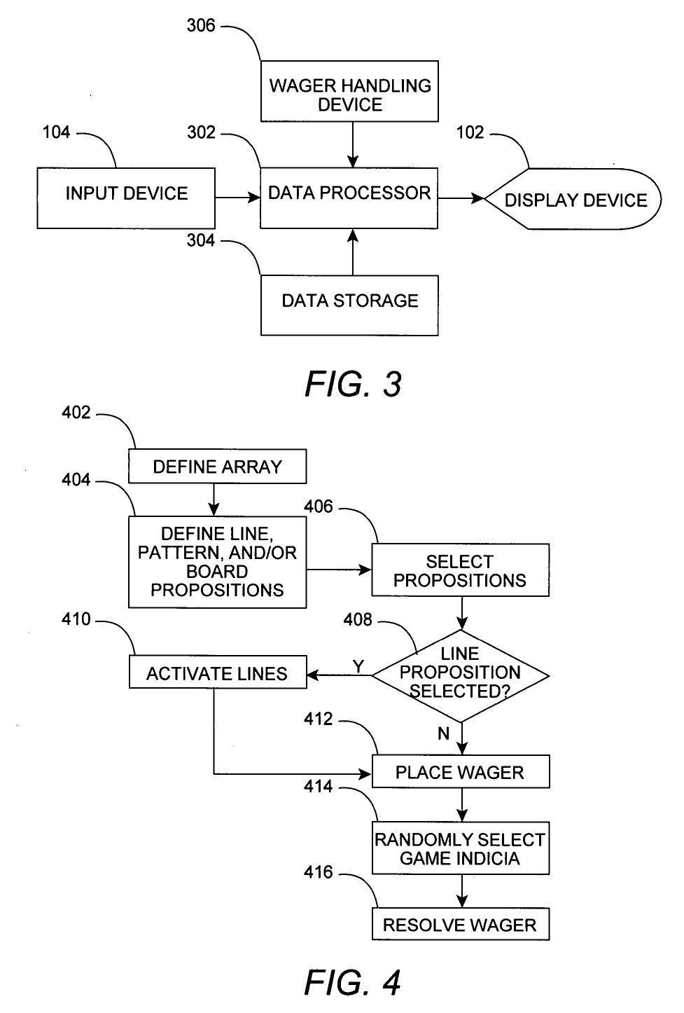

Referring to FIG. 4, an array of game indicia positions is defined 402. Optionally, the array has two or more dimensions. For example, in one optional embodiment, the array of game indicia positions may be rectangular, such as a square 3×3 array for a total of nine game indicia positions as shown in FIG. 1. Thus, in example of the figures, nine dice images are shown in three rows, each with three dice. It is noted, however, that the array may take any shape or size and may include arrays that are non-rectangular, or have rows or columns of different size, or have rows or columns offset from one another. An example could include six game indicia positions arranged in a triangle.

Returning to FIG. 4, proposition wagers are defined 404. In an optional embodiment in which players may select line propositions, described in greater detail below, subsets of the array are defined. The subsets could take any form, and it is noted that the subsets could be of any size or configuration. For example, in one optional embodiment, the subsets are the rows, columns, and diagonals of the array. In the case of a 3×3 array, this would give eight subsets.

Players select 406 one or more proposition wagers and place a wager 412. The proposition wagers may take any form, including line propositions, pattern propositions, and board propositions. Line propositions are propositions that a selected subset will contain selected game indicia. For example, in one optional embodiment, a line proposition may be offered that a selected subset will contain a selected double of game indicia, a selected triple of game indicia, any straight (consecutive game indicia with or without regard to position or sequence), or any triple of game indicia. In the example of FIGS. 1 and 2A, these line propositions would be placed by pressing the DBL button 214 corresponding to the selected number, the TRIP button 216 corresponding to the selected game indicium or indicia, the ANY STRAIGHT button 210, or the ANY TRIPLE button 212, respectively. It is noted that these are examples only, and should not be considered limiting. In selecting line propositions 408, it is contemplated that a player may activate 410 subsets for that subset to be eligible for an award if the line proposition is fulfilled. In an optional embodiment, the player activates subsets by allocating a wager to the subsets the player wishes to activate.

For example, in FIGS. 1 and 2A, the subsets (or lines) are the three rows, three columns, and two diagonals of the rectangular 3×3 array. Although the game could be conducted without requiring player activation of subsets, in this optional embodiment, players activate one or more subsets for line propositions. A player may be permitted to activate subsets in groups, such as by pressing a 1 LINE button 202 to activate one subset or line, a 3 LINES button 204 to activate three subsets or lines, a 6 LINES button 206 to activate six subsets or lines, or an MAX LINES button 208 to activate all subsets or lines. In this optional embodiment, each line activated may increase the total units deducted from the player's bank with each line wager. For example, if a player activates eight lines by pressing the MAX LINES button 208, each actuation of a line wager button may commit eight units (one unit per active line), whereas a player activating only three lines by pressing the 3 LINES button 204, each actuation of a line wager button may only commit three units. Thus, a player wishing to activate the maximum number of lines and wager two units per line for ANY STRAIGHT, for example, would actuate the MAX LINES button 208, then actuate ANY STRAIGHT button 210 twice, thereby committing sixteen total units (two coins multiplied by eight active lines).

In addition to activating subsets, players in this optional embodiment also select the propositions for those lines. In the optional embodiment of FIGS. 1 and 2, the player selects line propositions that may be fulfilled by any active subset. For example, if the player activates all subsets using the MAX LINES button 208, then selects the double “four” line proposition using the DBL button 214 under the image of a die with four pips, the line proposition will be fulfilled if any row, line, or diagonal contains two game indicia representing a four. Conversely, if the player activates only one subset by pressing the 1 LINE button 202, and that one line is the center row of the array, the line proposition will be fulfilled if the center row contains two or more game indicia representing a four, but will not be fulfilled if double “fours” appears in the upper row, the lower row, a column, or a diagonal.

Pattern propositions may be offered. Pattern propositions are fulfilled when game indicia appear in a pattern within the array. In an optional embodiment, lines do not have to be activated to place a pattern proposition; in an optional embodiment, the patterns are activated for the purpose of the pattern proposition wager when a pattern proposition wager is selected. The patterns could take any form. In an optional embodiment, the pattern could be a single game indicium position, selected by the player, where the player predicts one or more designated game indicia will appear.

In an additional or alternate optional embodiment, the pattern could include multiple game indicium positions, such as an X pattern formed by intersecting diagonals, an L, T, H, +, box, or like pattern formed by one or more intersecting columns or rows, an angle or triangle pattern formed by one or more diagonals intersecting one or more columns or rows, a four corners pattern, a blackout pattern, or game indicia in any other pattern. In an optional embodiment in which multiple game indicium positions are included in the pattern, it is contemplated that the game indicia appearing within the pattern could have any relationship with one another. For example, in one optional embodiment, a pattern proposition is satisfied when the game indicia match. Thus, in such an example, an X-pattern proposition is satisfied when the game indicia along the intersecting diagonals of the array match one another.

In the example illustrated in FIGS. 1 and 2, a pattern proposition is offered which is fulfilled when the game indicia in the four corners of the array match one another. This pattern proposition is selected by the player by actuating the MATCH 4 CORNERS button 224. In the example illustrated, this proposition wager is satisfied when any game indicia in the designated pattern match. That is, in such an optional embodiment the player may be permitted to place an “any” pattern proposition, where the player is rewarded without regard to which game indicia appear so long as the game indicia appear in the designated pattern. For example, an “any” MATCH 4 CORNERS proposition would be satisfied if “1” appears in each corner or “2” appears in each corner or “3” appears in each corner, and so forth.

In an additional or alternative optional embodiment, the player may be allowed to specify the game indicia to appear, optionally at a higher pay out rate. In such an optional embodiment, a “specified” pattern proposition may be offered in which the player specifies a pattern and a game indicia. For example, a “5” X-PATTERN proposition may be satisfied when “5” appears in game indicia positions along the intersecting diagonals, but would not be satisfied if “1,” “2,” “3,” “4,” or “6” appear along the intersecting diagonals. It is noted that these “any” pattern propositions and “specified” pattern propositions could be applied to any pattern proposition.

Board propositions may also be offered. Board propositions are propositions in which the entire board must be examined to determine if the proposition is fulfilled. In the particular embodiment illustrated, no set or subset must be activated for board propositions. That is, to place a board proposition in this optional embodiment the player would not be required to activate any lines because the board propositions would occur across the array. However, it is contemplated that in other optional embodiments, players may be required to place line wagers, or activate one or more lines, to select a board proposition. In this example, board propositions include propositions that the game indicia in the array are all odd or all even, that the game indicia in the four corner game indicia positions match, that the sum of all game indicia is within a selected range. In the example of FIGS. 1 and 2, these board propositions would be selected by pressing the ALL ODD/ALL EVEN button 218, BIG (36-54) button 220, or SMALL (9-27) button 222, respectively. Again, these are examples only and should not be considered limiting.

In a hybrid of line propositions and board propositions, in one optional embodiment, propositions may be offered in which players select a game indicia and are rewarded based on the appearance of that game indicia in the activated lines. In one example of such a single game indicia proposition, the player designates a single game indicia. Multiple active lines are examined and the proposition is fulfilled if a certain quantity of activated lines include the selected game indicia. Thus, in one optional embodiment, a single game indicia proposition may be fulfilled if, for example, seven or more of nine active lines contain the single game indicia specified. In an optional embodiment, the pay out for fulfilling the proposition may be adjusted if the specified single game indicia appears in more or fewer active lines. Similarly, the pay out for fulfilling the proposition may be adjusted for multiple occurrences of the specified single game indicia within one or more active lines.

Game indicia are randomly selected 414 at each game indicia position. In an optional embodiment, the game indicia at each position are independently selected. That is, the selection of game indicia at any one position is not dependent upon selection of game indicia in any other position as would be the case in a reel slot machine using defined reel strips. In the example of the figures, the game indicia may be separately selected, i.e. nine different selections of game indicia, or the game indicia may be selected as a group, i.e. one selection is of a nine member set of game indicia. It is noted that the probability associated with selection of any game indicia may be determined according to the game. For example, in the example of FIGS. 1 and 2, there may be 1:6 probability that any die face may be selected. That is, there may be an equal probability that any single face may be “rolled.” However, in other games, it is contemplated that the probability of certain outcomes may be weighted to occur more or less often.

The game indicia of the array are examined to determine if the propositions wagered upon by the player are fulfilled. As previously discussed, for a line proposition to be fulfilled, a subset (optionally an active subset) of the array must contain the game indicia of the proposition. For a pattern proposition to be fulfilled, the array must contain a designated pattern of game indicia meeting one or more criterion; the proposition may include a designation of the pattern, a designation of the game indicia, or both. For a board proposition to be fulfilled, the array must contain game indicia fulfilling the proposition.

The wager is resolved 416 by collecting wagers on unfulfilled propositions and rewarding wagers on fulfilled propositions. The rewards may take many different forms. In the example of the figures, a pay table, such as that shown in Table 1, of propositions and pay outs may be used.

TABLE 1

| | Pay Out |
|---|---|
| Board Propositions | |
| Big (36-54) | 2:1 |
| Small (9-27) | 2:1 |
| All Odd/All Even | 200:1 |
| Pattern Propositions | |
| Match 4 Corners | 180:1 |
| Line Propositions | |
| Any Straight | 8:1 |
| Double | 12:1 |
| Any Triple | 32:1 |
| Triple | 185:1 |

It should be noted that the propositions offered and the pay outs associated therewith, are exemplary only and should not be construed as limiting. For example, the pay table shown on the device in FIG. 1 illustrates alternate optional pay outs for the propositions offered.

Referring to the example of FIGS. 1 and 2B, the player has activated eight lines by pressing the MAX LINES button 208 and selected four line propositions. The player was wagered one unit per line on double “twos,” one unit per line on triple “twos,” one unit per line on “any triple,” and one unit per line on “any straight” as shown in the windows adjacent to the buttons used to select the propositions. Additionally, the player has wagered five units on “big” meaning that the player will be rewarded if the sum of the game indicia falls between thirty-six and fifty-four. The net wager by the player is thirty-seven units (e.g. one unit times eight activated lines times four line wagers equals thirty-two units committed to line propositions, plus five units committed for a board proposition, totals thirty-seven units).

In an example where the game indicia selected are positioned as shown in FIG. 1, the player is rewarded with fifty-five units based on the pay table shown on the gaming machine of FIG. 1. Specifically, in this example, the array includes two subsets (the top row and the middle column) that include double “twos” which results in a payout of twenty units (ten times one unit per line times two lines). Also, the center row includes triple “threes” which fulfils the “any triple” line proposition. This results in an additional win of thirty units (thirty times one unit per line times one line). Finally, the rightmost column includes the indicia “2,” “3,” and “4” which forms a straight and fulfils the “any straight” proposition. This results in an additional win of five units (five times one unit per line times one line). It is noted that the “big” proposition was not fulfilled so the player is not rewarded.

In addition to proposition wagers, a method according to the present invention may also include rewards for the player without requiring any specific action by the player to activate the award. In one optional embodiment, the present invention could include a mystery pay that is triggered randomly, or based on some standard other than the game indicia in the array. For example, a player may be awarded such a mystery pay based on a counter tracking coin-in, time of play, level of play, quantity of games, quantity of games in which a particular proposition is selected, or any other measure. In another example, a player may, on each game, have a probability of randomly receiving a mystery pay award.

In another such reward, a player may be eligible for a bonus award, such as a fixed pay jackpot or a progressive jackpot, for obtaining a bonus outcome in the array. Bonus outcomes could take any form. In one optional embodiment, the player may be eligible for a bonus award for obtaining a bonus outcome of a specified quantity of matching game indicia. It is further noted that multiple bonus awards may be offered. For example, in one optional embodiment, the game may include separate bonus awards for obtaining seven, eight, or nine matching symbols in a nine symbol array. In an optional embodiment in which the bonus award is a progressive jackpot, a portion of the wager placed by the player may be allocated to the progressive jackpot so that the size of the progressive jackpot increases until it is awarded and reset to a base value.

While certain embodiments of the present invention have been shown and described it is to be understood that the present invention is subject to many modifications and changes without departing from the spirit and scope of the invention presented herein.

I claim:

1. A method for conducting a wagering game using game indicia for a player, comprising:
defining an array of game indicium positions having at least two dimensions;
defining at least one proposition selected from the group of propositions consisting of line propositions satisfied by game indicia appearing in a designated subset of said array, pattern propositions satisfied by game indicia appearing in a pattern within said array, and board propositions satisfied by characteristics of the game indicia throughout at least a subset of said board;
receiving a wager from a player, said wager including a selection of at least one of said propositions;
randomly selecting a game indicium for each game indicium position; and
resolving said wager based on the game indicia in said array.

2. The method of claim 1 wherein each game indicium has an equal probability of being randomly selected.

3. The method of claim 2 wherein said game indicia are the faces of a die such that each face has an equal probability of being selected.

4. The method of claim 1 wherein said step of selecting a game indicium for each game indicium position includes selecting each game indicium separately.

5. The method of claim 1 wherein said step of defining at least one proposition comprises defining at least one line proposition satisfied when one or more designated game indicia appear in a designated subset of said array.

6. The method of claim 5 wherein said step of receiving a wager includes receiving from said player an allocation of said wager among predefined subsets in said array such that said line proposition is satisfied only when one or more designated game indicia appear in a designated subset of said array to which said wager has been allocated.

7. The method of claim 1 wherein said step of defining at least one proposition comprises defining at least one pattern proposition satisfied when one or more game indicia appear in a designated pattern in said array.

8. The method of claim 7 wherein said array is a rectangular array formed by columns and rows of game indicium positions and said pattern propositions are satisfied when game indicia appear in a predefined pattern formed by at least one intersecting column and row.

9. The method of claim 1 wherein each game indicia has at least one defined characteristic and said step of defining at least one proposition comprises defining at least one board propositions satisfied when all the game indicia in said array have a common characteristic.

10. A method for conducting a wagering game using game indicia for a player, comprising:
defining a two-dimensional array of game indicium positions;
defining at least one proposition selected from the group of propositions consisting of line propositions satisfied by game indicia appearing in a designated subset of said array, pattern propositions satisfied by game indicia appearing in a pattern within said array, and board propositions satisfied by characteristics of the game indicia throughout at least a subset of said board;
receiving a wager from a player, said wager including a selection of at least one of said propositions;
randomly and separately selecting a game indicium for each game indicium position, wherein each game indicium has an equal probability of being randomly selected; and
resolving said wager based on the game indicia in said array.

11. The method of claim 10 wherein said game indicia are the faces of a die such that each face has an equal probability of being selected.

12. The method of claim 10 wherein said step of defining at least one proposition comprises defining at least one line proposition satisfied when one or more designated game indicia appear in a designated subset of said array.

13. The method of claim 12 wherein said step of receiving a wager includes receiving from said player an allocation of said wager among predefined subsets in said array such that said line proposition is satisfied only when one or more designated game indicia appear in a designated subset of said array to which said wager has been allocated.

14. The method of claim 10 wherein said step of defining at least one proposition comprises defining at least one pattern proposition satisfied when one or more game indicia appear in a designated pattern in said array.

15. The method of claim 14 wherein said array is a rectangular array formed by columns and rows of game indicium positions and said pattern propositions are satisfied when game indicia appear in a predefined pattern formed by at least one intersecting column and row.

16. The method of claim 10 wherein each game indicia has at least one defined characteristic and said step of defining at least one proposition comprises defining at least one board propositions satisfied when all the game indicia in said array have a common characteristic.

17. A device for conducting a game of chance for a player comprising:
a data processor;
a display device in communication with said data processor;
an input device in communication with said data processor;
a wager handling device in communication with said data processor; and
a data storage in communication with said data processor, said data storage adapted to store a predefined array of game indicium positions having at least two dimensions, at least one proposition selected from the group of propositions consisting of line propositions satisfied by game indicia appearing in a designated subset of said array, pattern propositions satisfied by game indicia appearing in a pattern within said array, and board propositions satisfied by characteristics of the game indicia throughout at least a subset of said board, and instructions executable by said data processor for conducting a wagering game comprising:
receiving a wager through said wager handling device and communicating the receipt of said wager to said data storage;
receiving input from said player through said input device, said input including a selection of at least one of said propositions;
randomly and separately selecting a game indicium for each game indicium position, wherein each game indicium has an equal probability of being randomly selected;
displaying said array containing said selected game indicia at said display device; and
resolving said wager based on the game indicia in said array.

18. The device of claim 17 wherein said data storage is adapted to store images of game indicia in the form of the faces of a die and said step of display said array containing said selected game indicia includes displaying said image of the selected game indicia in said array at said display device.

19. The device of claim 17 wherein said data storage is adapted to store at least one line proposition satisfied when one or more designated game indicia appear in a designated subset of said array.

20. The device of claim 19 wherein said step of receiving a wager includes receiving from said player an allocation of said wager among predefined subsets in said array such that said line proposition is satisfied only when one or more designated game indicia appear in a designated subset of said array to which said wager has been allocated.

21. The device of claim 17 wherein said data storage is adapted to store at least one pattern proposition satisfied when one or more game indicia appear in a designated pattern in said array.

22. The device of claim 21 wherein said data storage is adapted to store a rectangular array formed by columns and rows of game indicium positions and at least one pattern proposition that is satisfied when game indicia appear in a predefined pattern formed by at least one intersecting column and row.

23. The device of claim 17 wherein said data storage is adapted to store game indicia each having at least one defined characteristic and at least one board propositions satisfied when all the game indicia in said array have a common characteristic.
